(19) United States
(12) Patent Application Publication
(10) Pub. No.: US 2016/0171359 A1
(43) Pub. Date: Jun. 16, 2016

(54) ENERGY DEVICE

(71) Applicant: FRONIUS INTERNATIONAL GMBH, Pettenbach (AT)

(72) Inventors: Franz Niedereder, Fischlham (AT); Michael Dietrich, Marchtrenk (AT); Günther Neubacher, Neukirchen bei Lambach (AT)

(21) Appl. No.: 14/907,391

(22) PCT Filed: Jul. 24, 2014
(86) PCT No.: PCT/EP2014/065873

§ 371 Date: Jan. 25, 2016

(30) Foreign Application Priority Data
Jul. 25, 2013 (AT) A 599/2013

(51) Int. Cl. G06K 19/06

(52) U.S. Cl. CPC G06K 19/06037

(57) ABSTRACT

System (1) for supplying relevant device information for an energy device (2), wherein the dynamically generated code outputted by the output unit (2E) of the energy device (2) is captured by a mobile terminal (3) of the user, and wherein, after the captured dynamically generated code is successfully decrypted by a decryption unit (3D) of the mobile terminal (3), the mobile terminal (3) establishes a data connection to a server (6) which supplies device information data for the energy device (2) which are relevant for the context specified in the context data.

The invention relates to an energy device for collecting, storing, charging or supplying electrical energy and in particular to an energy supply device for supplying electrical energy for a welding torch, an energy collection device for collecting electrical energy from solar radiation and/or wind power, an energy storage device for storing electrical energy and a charging device for charging energy storage cells, in particular batteries.

After being supplied to the customer, devices of this type for collecting, storing or supplying electrical energy are installed at the place of use thereof and started up. When conventional energy devices are started up, in many cases a user has to carry out various start-up steps, possibly configurations. This conventionally takes place using accompanying operating instructions. Further, when energy devices of this type are installed when being started up, incorrect settings or incorrect configurations may be put in place by the user, and trigger corresponding error messages. If the energy device has an integrated or connectable display, these error messages are generally displayed on this display of the energy device, for example in a corresponding error message. For example, the displayed error specifies an error number or the like. The accompanying operating instructions may contain details as to how an error of this type should be handled by the user or service technician on site. If the user or service technician does not manage to resolve the error which has occurred in the energy device using the routine specified in the operating instructions, conventionally the device manufacturer or device retailer is contacted by the user by telephone or in writing. For example, the user can call a service hotline of the device manufacturer and/or device retailer. If this hotline service centre is at full capacity, a user or service technician may have to wait in a queue for a relatively long time before he is connected by telephone to an appropriate technician who is familiar with the relevant energy device. In many cases, energy devices are used by users in their own private homes, for example for collecting electrical energy from solar radiation. In many cases, these users do not have the necessary technical expertise to describe the occurring errors accurately to a technician working in the service centre. Therefore, in many cases, inexperienced users are passed on several times before being connected to the actually appropriate technician who can answer their questions about handling the error.

A further drawback of the conventional procedure is that in many cases users not only describe the error incompletely, but also confuse the device type or read a displayed device number incorrectly. Therefore, a technician of the device manufacturer who is contacted over the service hotline may be working on the basis of an incorrect device type and/or incorrect error number and/or incorrect device number when giving advice on handling the error. This may for example mean that the technician's indications do not result in the error being resolved, and so the device remains non-functional. In these cases, it is generally necessary for a technician of the device manufacturer and/or device retailer to travel to the installation site of the terminal at the user's location and to resolve the error on site. Further, in many cases, because of confusions, incorrect replacement parts for a different device type or a different device version are delivered to the user or customer. This further delays the error resolution. The conventional procedure when starting up energy devices and/or resolving errors therein is thus itself relatively susceptible to errors, and in many cases leads to considerable delays in the error resolution on the installed energy device. Further, supplying the necessary information and assisting in the installation and/or error resolution is relatively complex, and so for example a continuously available service hotline is necessary.

Therefore, an object of the present invention is to provide a method and a system for supplying relevant device information data for an energy device which efficiently and reliably assists a user in installation, start-up, operation and error handling.

This object is achieved according to the invention by an energy device having the features set out in claim 1.

The invention accordingly provides an energy device for collecting, storing or supplying electrical energy comprising

a code generation unit, which generates a code as a function of context data of the energy device, and comprising
an output unit, which outputs the dynamically generated code for receipt by a mobile terminal of a user.

In one possible embodiment, the output unit is integrated into the energy device. In an alternative embodiment, the output unit is connected to an interface of the energy device.

In one embodiment of the energy device according to the invention, the context data of the energy device comprise internal context data and/or external context data.

These context data are preferably stored in a context data store of the energy device, the code generation unit having access to the context data store for generating the code as a function of the context data read out from the context data store.

In one possible embodiment of the energy device according to the invention, the internal context data comprise device-specific context data.

These device-specific context data preferably comprises a device type of the energy device, a device ID of the energy device and in particular a manufacturer ID or a serial number of the energy device, pre-set or configurable device parameters of the energy device, a current device setting or equipment provision of the energy device and/or a network address of the device manufacturer of the relevant energy device.

The external context data which are stored in the context data store of the energy device preferably comprise environment-specific context data, in particular a geographical position of the energy device, and/or user-specific context data, in particular data relating to the user's first language and/or his qualification level for operating the energy device.

In a further possible embodiment of the energy device according to the invention, context data are captured automatically by sensors of the energy device and/or inputted by the user via a user interface of the energy device or via a wireless interface of a mobile terminal connected to the energy device.

In one possible embodiment of the energy device according to the invention, the integrated or connected output unit of the energy device comprises an optical display unit which displays a dynamically generated two-dimensional optical code.

This dynamically generated two-dimensional optical code is preferably captured by a camera of the mobile terminal.

In one possible embodiment, the dynamically generated optical two-dimensional code which is displayed by the optical display unit and captured by the camera of the mobile terminal is a QR code.

In a further possible embodiment of the energy device according to the invention, the output unit comprises an acoustic output unit, which outputs a dynamically generated audio code or sound sequence which can be captured by a microphone of the mobile terminal of the user.

In a further possible embodiment of the energy device according to the invention, after the captured code is successfully decrypted, the mobile terminal of the user automatically establishes a data connection over a network to a server which supplies device information data which are relevant to the energy device for the context specified in the context data.

In one possible embodiment, the server may be a server of the device manufacturer or the device retailer.

In a further possible embodiment of the energy device according to the invention, the relevant device information supplied by the server are transmitted to the mobile terminal of the user over the network.

In a further possible embodiment of the energy device according to the invention, the relevant device information data of the energy device which are received by the mobile terminal of the user from the server over the network are prepared by a data processing unit of the mobile terminal or displayed to the user directly on a display of the mobile terminal.

In a further possible embodiment of the energy device according to the invention, the relevant device information data received from the server are passed on at least in part from the mobile terminal to the energy device via a wireless interface. In this way, the terminal can for example supply the energy device with data from the Internet.

In a further possible embodiment of the energy device according to the invention, the relevant device information data which are passed on from the mobile terminal to the energy device via the wireless interface are displayed to the user on the optical display unit of the energy device or outputted to the user acoustically via the audio output unit of the energy device.

In a further possible embodiment of the energy device according to the invention, the relevant device information data displayed on the display of the mobile terminal and/or the optical display unit of the energy device comprise an operating instruction for adjustment, operation and/or context-specific error handling, assembly instructions, equipment provision instructions, calibration instructions and/or order forms for replacement parts.

In one possible embodiment of the energy device according to the invention, the energy device is an energy supply device for supplying electrical energy for a welding torch.

In a further possible alternative embodiment of the energy device according to the invention, the energy device is an energy collection device for collecting electrical energy from solar radiation and/or wind power.

In a further possible alternative embodiment of the energy device according to the invention, the energy device is an energy storage device comprising storage cells for storing electrical energy.

The storage cells may be electrochemical energy storage cells and/or fuel cells.

In a further possible alternative embodiment of the energy device according to the invention, the energy device is a charging device for charging energy storage cells, in particular batteries.

The invention further provides a system for supplying relevant device information data for an energy device having the features set out in claim 14.

The invention accordingly provides a system for supplying relevant device information data for an energy data which comprises a code generation unit, which dynamically generates a code as a function of context data of the energy device, and an output unit, which outputs the dynamically generated code for receipt by a mobile terminal of a user, the dynamically generated code outputted by the output unit being captured by the mobile terminal of the user, and, after the captured dynamically generated code is successfully decrypted by a decryption unit of the mobile terminal, the mobile terminal establishing a data connection to a server which supplies device information data which are relevant to the energy device for the context specified in the context data.

The invention further provides a method for supplying relevant device information data for an energy device, having the features set out in claim 15.

The invention accordingly provides a method for supplying relevant device information data for an energy device comprising the steps of:

a code generation unit of the energy device generating a code as a function of context data; an output unit of the energy device outputting the dynamically generated context-specific code to a mobile terminal of a user;
a data connection being established between the mobile terminal of the user and a server after the dynamic, context-specific code is decrypted by a decryption unit of the mobile terminal; and
the server supplying relevant device information data which are relevant for the context specified in the context data.

In the following, possible embodiments of the system according to the invention and the method according to the invention for supplying relevant device information data for an energy device according to the invention are described in greater detail with reference to the accompanying drawings, in which:

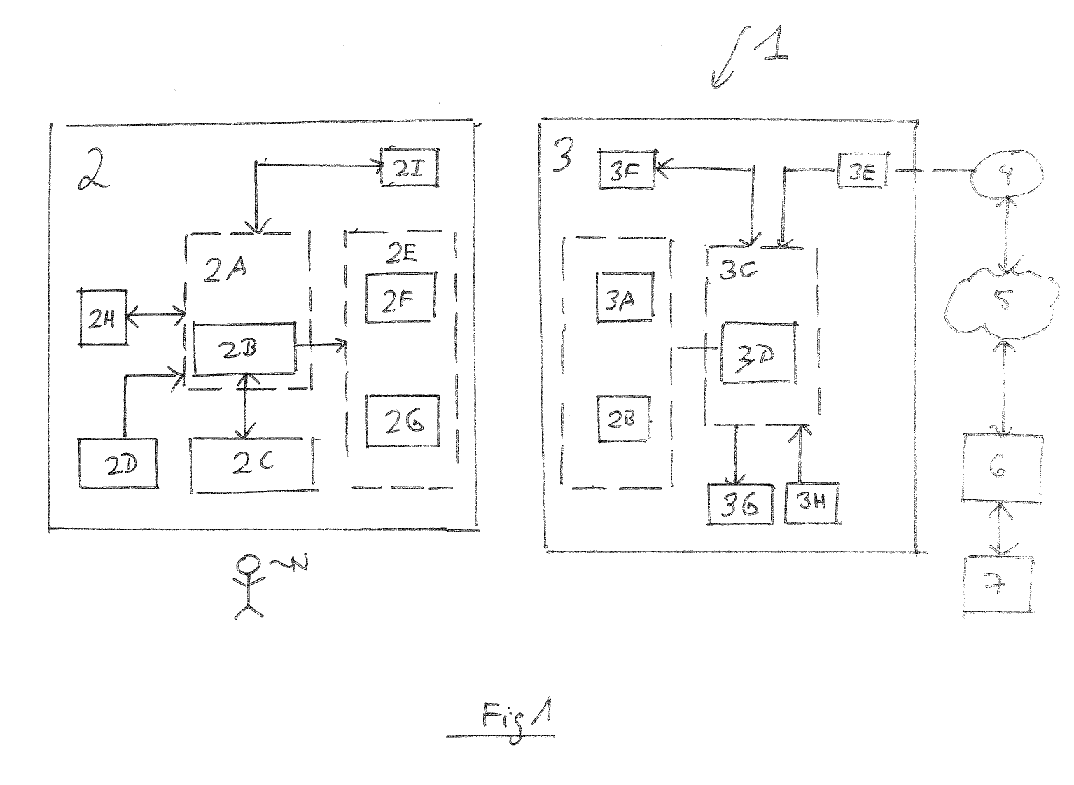

FIG. 1 is a block diagram of an embodiment of a system according to the invention for supplying relevant device information data for an energy device;

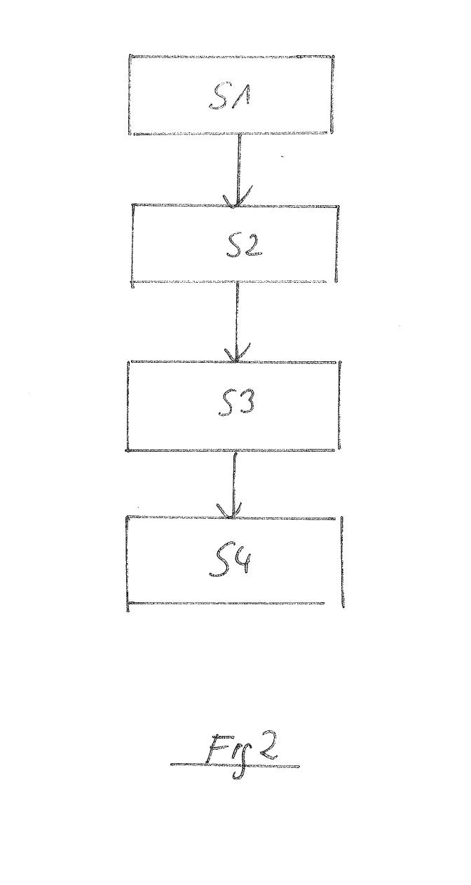

FIG. 2 is a flow chart of an embodiment of a method according to the invention for supplying relevant device information data for an energy device.

As can be seen in FIG. 1, the system 1 for supplying relevant device information data for an energy device 2 comprises a mobile terminal 3, which is connected via an access network 4 and a data network to a system server 6, which for example has access to a database 7. The server 6 may be for example the server of the device manufacturer. The server 6 may also be integrated into the energy device 2. The energy device 2 is a device for collecting, storing or supplying electrical energy or for charging batteries. In one possible embodiment, the energy device 2 is an energy supply device for supplying electrical energy for a welding torch. In a further possible embodiment, the energy device 2 may also be an energy collection device for collecting electrical energy from renewable energies, for example an energy collection device for collecting electrical energy from solar radiation and/or wind power. For example, the energy device 2 may be an inverter which converts direct current DC collected by solar panels into an alternating current AC for a power supply network. Further, in a further embodiment, the energy device 2 may be an energy storage device which comprises a plurality of storage cells for storing electrical energy. In one possible embodiment, these energy storage cells are electrochemical energy storage cells. Further, the energy storage cells may also be fuel cells. In a further possible embodiment, the energy device 2 is a device for charging energy storage cells, in particular batteries.

The energy device 2 has a data processing unit 2A which may comprise one or more microprocessors. The data processing unit 2A contains a code generation unit 2B, which dynamically generates a code as a function of context data of the energy device 2. The energy device 2 preferably contains a context data memory 2C in which context data of the energy device 2 are stored. The context data memory 2C may be integrated into the energy device 2. Further, the context data memory 2C may also be a replaceable data carrier or a USB stick or the like. In one possible embodiment, the energy device 2 has a user interface 2D, via which a user or a service technician or a private individual can input context data of the energy device 2 into the context data memory 2C.

The energy device 2C further has an output unit 2E, which provides the dynamically generated code, outputted by the code generation unit 2B, to the mobile terminal 3. In one possible embodiment, the output unit 2E may comprise an optical display unit 2F and/or an audio output unit 2G. The code may also be displayed in a device, in particular a PC, laptop or projector, connected to the energy device 2 via an interface.

The code generation unit 2B generates a code as a function of the context data stored in the context data memory 2C of the energy device 2. For this purpose, the code generation unit 2B has access to the context data memory 2C, via the data processing unit 2A, for generating the codes as a function of the context data read out from the context data memory 2C. The context data in the context data memory 2C may change dynamically over time, in particular if an error occurs in the terminal 2, for example occurring during start-up and/or during continuous operation of the energy device 2. A code is thus generated and displayed automatically from the current context data which the user is currently configuring and/or examining. In this context, it is assumed that generation of the code is provided.

The context data of the energy device 2 may comprise internal context data and/or external context data. The internal context data comprise for example device-specific context data, in particular a specific device type or a device version of the energy device 2. Further, the context data may comprise a device ID of the energy device 2, in particular a manufacturer ID or a serial number of the device manufacture of the energy device 2. The internal context data stored in the context data memory 2 further comprise pre-set or configurable device parameters of the energy device 2, in particular configuration settings of parameters of the energy device 2. As well as a current device setting, the internal context data may also additionally include a current equipment provision of the energy device 2, for example a welding wire laid in a welding device 2. Further, the context data preferably comprise a network address, for example a URL, of the server 6 of the system 1. The network address specifies for example the server address of the device manufacture of the relevant energy device 2.

As well as the internal context data, in one possible embodiment external context data may also be contained in the context data memory 2C. These external context data comprise for example environment-specific context data, in particular a geographical position of the energy device 2 or the coordinates of the installation site of the relevant energy device 2. In addition, the external context data in the context data memory 2C may also contain user-specific context data, in particular data relating to the first language of the customer or user N or his qualification level for operating the energy device 2. For example, these context data may specify that the user N speaks English as a first language. Further, the context data may for example specify that the user N is a private user who has no particular technical qualifications for installing or operating the energy device 2. In one possible embodiment of the energy device 2, it also has sensors 2H which can automatically capture context data of the energy device 2. For example, the context data captured using sensors specify a current operating state of the energy device 2. For example, the context data may specify an energy charging state of storage cells of an energy storage device 2. The sensors 2H may also supply external context data, for example the strength of current solar radiation.

In one possible embodiment, the various context data, for example the network address for example of the device manufacturer server and the serial number of the energy device 2 and further parameters, for example an error code of a displayed error or configuration setting parameter, may be combined or linked in a text string which is supplied to the code generation unit 2B. A text string of this type may for example read http://Serveradresse?argument1&argument2 for a server. Accordingly, further arguments can be added using “&”. Of course, the code may also point to a mail server and/or only contain text data. Accordingly, the text data may be displayed directly on the terminal.

The code generation unit 2B carries out a coding algorithm and generates, from the supplied text string or context data, a dynamic code which is passed to the output unit 2E. An optical display unit 2F of the energy device 2, for example a TFT screen, may output a dynamically generated optical code. This optical code is for example a two-dimensional optical code, in particular a QR code. Moreover, the optical code may also be a barcode or the like.

In one possible implementation, in addition or as an alternative to the dynamically generated optical code, the code generation unit 2B generates an acoustic code, which is outputted by a loudspeaker of the audio output unit 2G as a series or sequence or sounds. This is advantageous in possible applications in which the device 2 is installed in dark regions with little light or in applications in which the user N cannot bring a mobile terminal 3 close enough to the optical display unit 2F of the energy device 2 because of the fitting of the energy device 2, and the optically displayed code, in particular a QR code, can thus only be captured with difficulty by a camera 3A of the mobile terminal 3. Further, an audio output unit 2G may preferably be used if the energy device 2 is relatively small and there is no space for an optical display unit. Further, in many cases the technical complexity of implementing an audio display unit 2G in an energy device is lower than for implementing an optical display unit 2F. In a further possible embodiment, the output unit 2E has both an optical display unit 2F and an audio output unit 2G, in such a way that the generated code can be passed to the mobile terminal 3 both optically and acoustically. As a result, incorrect captures of the outputted dynamically generated code by the mobile terminal 3 can be reduced, since it is checked that the received codes are identical.

In a further possible embodiment of the energy device 2 according to the invention, the energy device 2 has an interface 21, by means of which wireless unidirectional or bidirectional radio data transmission can take place with the mobile terminal 3.

The mobile terminal 3 shown in FIG. 1 may for example be a mobile telephone of the user N. Further, the mobile terminal 3 may also be a mobile computer/tablet or a mobile laptop. The mobile terminal 3 contains a camera 3A which optically captures the dynamically generated optical code visually displayed in the optical display unit 2F. In this embodiment, the dynamically generated two-dimensional optical code is displayed and captured by the camera 3A in a visible frequency range. In further possible embodiments, the dynamically generated two-dimensional optical code is displayed in an invisible frequency range, for example in an infrared frequency range. This may take for example to prevent manipulation or make it more difficult. In a further possible embodiment, a plurality of dynamically generated two-dimensional optical codes are displayed on the optical display 2F simultaneously for capture by the camera 3A. These two-dimensional optical codes may also be in different frequency ranges. The displayed optical two-dimensional code changes dynamically over time as a function of the current context data of the energy device 2. If for example the energy device 2 passes from a first operating state into a second operating state, the displayed dynamically generated optical code displayed on the optical display unit 2F changes automatically. To prevent errors in the capture, the displayed or outputted code may have some redundancy. The redundancy may vary between applications. For example, the code redundancy is greater in a safety-critical application or a safety-critical energy device 2 than in less safety-critical energy devices.

In one possible embodiment, the mobile terminal 3 may also contain a microphone 3B as well as the camera 3A, so as to capture the acoustically outputted dynamically generated code acoustically. In the embodiments shown in FIG. 1, the camera 3A and the microphone 3B are connected to a data processing unit 3C of the mobile terminal 3. This data processing unit 3C contains a decryption unit 3D, which is provided to decrypt a dynamic code captured using the camera 3A and/or the microphone 3B. After the captured dynamically generated code is successfully decrypted by the decryption unit 3D of the mobile terminal 3, the mobile terminal 3 automatically establishes a data connection to the server 6 via an interface 3E. In this context, a context-dependent link to a particular data range within the data base 7 is produced, causing the desired, relevant device information data corresponding to the current context data to be supplied by the server 6.

In the embodiment shown in FIG. 1, the mobile terminal 3 establishes a corresponding context-dependent link to a system server, in particular a server of the device manufacturer of the energy device 2, automatically via an access network 4 and the data network 5, for example a local data network or the Internet.

As can further be seen in FIG. 1, the mobile terminal 3 further optionally has a radio interface 3F, by means of which data can additionally be exchanged between the energy device 2 and the mobile terminal 3. For example, this may be a WLAN interface or NFC interface. In one possible embodiment, the mobile terminal 3 further comprises a display 3G and its own user interface 3H. In one possible embodiment, the relevant device information data supplied by the server 6 may be transmitted to the mobile terminal 3 of the user N via the data network 5. In one possible embodiment, the relevant device information data of the energy device 2 received by the mobile terminal 3 of the user N from the server 6 over the data network 5 are prepared by the data processing unit 3C of the mobile terminal 3 and subsequently displayed on the display 3G. In an alternative embodiment, the received relevant device information data of the energy device 2 are displayed to the user N directly on the display 3G of the mobile terminal 3, without preparation.

In one possible embodiment, the relevant device information data received from the server 6 are passed on at least in part from the mobile terminal 3 to the energy device 2 via the wireless interface, for example WLAN interface. The relevant device information data, passed on from the mobile terminal 3 via the wireless interface to the energy device 2, can be displayed to the user N there on the optical display unit 2F of the energy device 2 and/or outputted via the audio output unit 2G of the energy device 2. For example, a corresponding spoken instruction can be outputted via a loudspeaker of the audio output unit of the acoustic output unit 2G of the energy device 2. In one possible variant configuration, the user thus has the option of receiving the relevant device information data of the energy device 2 both on the display 3G of his mobile terminal 3 and via the output unit 2E of the energy device 2.

In one possible variant configuration, the energy device 2 is a power supply for a welding torch. In one embodiment, a homepage address of the power supply is stored in the context data memory 2C, for example. This homepage address or link may read differently for each device type of the power supply and, depending on the individual configuration in each case, after each time the power supply is switched on. In one possible variant configuration, a text string can be generated from the network address and/or further device parameters, for example the serial number of the energy device 2, and is converted by the code generation unit 2B of the energy device or of the power supply 2, by an algorithm carried out as a function of the context data, into a dynamically generated code, which is displayed for example as an optical two-dimensional code in the optical display unit 2F of the power supply 2. The displayed two-dimensional code is optically captured by the camera 3A of the mobile terminal 3, the data processing unit 3C of the mobile terminal 3 automatically generating a context-dependent link to a matching section on the homepage of the device manufacturer without further inputs from the user N being required. When displayed code is scanned, links to individual documents (Web pages) are generated, which explicitly provide related context-specific information which is relevant to the device to the user N, for example version information, TCO data, running time data and settings which should be made on the energy device 2, for example the power supply.

In one possible embodiment, for example a link to a matching section in operating instructions for the energy device 2 is automatically produced, for example to a welding routine described therein which contains welding instructions. Further, software options may be set out therein, as well as a brief guide to parameters for processes of the power supply 2. Further, for example warranty notices for the energy device 2 may be stored therein. Further, a link to a document library or individual documents or links to calibration documents, service documents or assembly instructions may be established automatically. Further, a link to contact addresses may be established, for example to international or domestic collection addresses. It is further possible for a link to order forms to be generated, for example for a request for services, activation codes, replacement parts or special programs. It is further possible to provide accounting for services rendered, for example by also sending machine data or print data.

In one possible embodiment, in which the data connection or the link is established directly on the basis of power supply information of the energy device or the power supply 2, such as serial numbers, print data etc., in one possible embodiment a called Web form, for example an order form, may already be filled out in part on the basis of context data of this type, in particular with reliable information data. For example, a serial number of the device manufacturer may already be entered in a Web form of this type. As a result, typing errors by the user N in complex serial numbers can be prevented. It is thus possible to transmit brief information dependent on the power supply, such as the product name, serial number, user reference or the like, to the server 6 of the device manufacturer as advance information for service and/or repair purposes.

As well as the context data, external context data, in particular environment-specific or user-specific context data, may also be taken into account in the dynamic generation of the code. These environment-specific context data are for example coordinates or the installation site of the welding device 2. The user-specific context data specify for example a first language of the user N. In this way, the relevant device information is supplied by the server 6 in the first language of the user by accessing a corresponding language field in the database 7. Further, the language area in which the energy device 2 has been installed can be determined from the installation site or the coordinates.

In one possible embodiment, if an error occurs, the user N can direct an error description or a query to the server 6 of the device manufacturer via the user interface 2D or via the user interface 3H of the mobile terminal 3. Data or keywords which are manually inputted in this manner may also constitute context data. Context data may be intrinsic, in other words preconfigured in the context data memory 2C, or else be inputted at least in part by the user N. Further, context data may also be captured using sensors, for example using image sensors 2H of the energy device 2. For example, a state of charge SoC of an energy storage device 2 may be captured as context data. If for example the state of charge is low and the user N directs a query to the system server to resolve an error which has occurred, said server 6 may for example automatically link to operating instructions which provide the user N with a routine for correcting the error. In this simple example, the user N could be told to increase the state of charge SoC, for example by plugging a mains plug into a mains supply and waiting for some amount of time until the state of charge has increased sufficiently. The link to this specific region in operating instructions which may be very extensive is provided automatically by way of the dynamically generated code on the basis of internal and external context data, which may change dynamically in accordance with the current state of the energy device 2.

In the system 1 as shown in FIG. 1, the dynamically generated code is captured wirelessly or contactlessly, in other words an image is captured by a camera 3A and/or a sound is captured by means of the microphone 3B of the portable mobile terminal carried by the user N.

The mobile terminal 3 may for example be a smartphone of the user N. In this embodiment, the user N may download a corresponding application program or app which decrypts a captured dynamically generated code using the data processing unit 3C of the mobile terminal 3. In one possible embodiment, the user N can download the application program from the server 6 of the device manufacturer. In one possible embodiment, for this purpose the user or customer has to authenticate himself to the server 6 as authorised to do this, for example by specifying a customer number and/or an invoice or delivery number.

In a further variant configuration, the user N is automatically connected to a hotline service number of the device manufacturer by telephone, using the mobile terminal 3, in a context-dependent manner after the dynamically generated code is captured, the hotline number being suitable for the specific device type and/or the current state of the energy device 3. In this embodiment, the user N does not have to be tediously passed on from one service technician to another who ultimately has the necessary information for the specific device type. In this embodiment, the device information data are optionally additionally displayed to the user n a display unit 3G of the mobile terminal 3, whilst they are primarily conveyed by telephone. The device information data may also be generated and conveyed by telephone as a stored speech sequence and/or by speech synthesis. In one possible variant configuration, the device information data conveyed by telephone are additionally displayed on the display 3G of the mobile terminal 3 and/or the optical display unit 2F of the energy device 2. In this variant configuration, the user N obtained the information both as information data over the data network 5 and by telephone over a telephone network.

In a further variant configuration, while the user N is handling an error in the energy device 2, a service technician of the device manufacturer may additionally monitor, for example by means of sensors 2H provided on the terminal 2, whether the user N is actually acting in accordance with his instructions and/or the subroutine error handling prescribed in the database 7. For example, a dynamically generated code, in particular a QR code, is transmitted to the mobile terminal 3 for each change of state of the energy device 2, in such a way that the change in state within the energy device 2 can be detected and tracked by the server 6 or a corresponding service technician of the device manufacturer in real time. Corresponding device information data or instructions can also be conveyed to the user N via the mobile terminal 3 in real time as a reaction to the change in state.

In a further possible embodiment of the system 1 according to the invention, dynamically generated codes are generated periodically at adjustable time intervals, for example every 10 seconds. Depending on the type of the energy device 2, this time interval or observation interval may be adjusted. The energy device 2 may be observed during the installation phase, but also during the operating phase of the energy device 2. The transmitted device information data may also comprise a warning message relating to the current state of the energy device 2. If the decrypted dynamic code, which is based for example on context data captured using sensors, indicates a critical state of the energy device 2, the server 6 can automatically transmit a warning message to the mobile terminal 3 of the user N. The warning message may for example also be emitted at the mobile terminal 3 acoustically via a loudspeaker provided therein. As a result it is for example possible for the user N, when processing an error handling routine which he receives as device information data, to receive notices or warnings from the device manufacturer server 6 while the error handling is underway.

In the embodiment shown in FIG. 1, the system 1 comprises an energy device 2. In other variant configurations, a plurality of energy devices 2 may also be provided, which are optionally also interconnected. In this context, each energy device 2 may have its own output unit 2E or a graphical user interface GUI.

FIG. 2 contains a flow chart of a possible embodiment of a method according to the invention for supplying relevant device information data for an energy device 2.

In a first step S1, a code is generated as a function of context data of the energy device 2 by a code generation unit, for example the code generation unit 2B shown in FIG. 1. In this context, the code generation unit 2B for example reads context data from a context data memory 2C. The context data may comprise internal and/or external context data.

Subsequently, in a step S2, the dynamically generated context-specific code is outputted to a mobile terminal 3 of the user N by an output unit, for example by the output unit 2E shown in FIG. 1 of the energy device 2. In one possible embodiment, the generated code is outputted in an optical form, for example by outputting a two-dimensional optical code, in particular a QR code. It is further possible for the generated code to be emitted in an acoustic form, for example as a sound signal or sound sequence.

In a further step S3, a data connection or link is automatically established between the mobile terminal 3 of the user and a server, for example the server 6 shown in FIG. 1, after the dynamically context-specific code is decrypted, the link pointing to a range in which device information data specifically relevant to the context in question, comprising appropriate information or instructions, are located.

In a further step S4, the relevant device information data which are appropriate to the context, specified in the context data, of the energy device 2 are supplied by the server 6.

1. Energy device (2) for collecting, storing or supplying electrical energy, comprising
a code generation unit (2B), which dynamically generates a code as a function of context data of the energy device (2), and comprising
an output unit (2E), which outputs the dynamically generated code for capture by a mobile terminal (3) of a user (N).

2. Energy device according to claim 1, wherein the output unit (2E) is integrated into the energy device (2) or into a device, in particular a PC, laptop or projector, connected to the energy device (2) via an interface.

3. Energy device according to claim 1,
wherein the context data of the energy device (2) comprise internal context data and/or external context data.

4. Energy device according to claim 3,
wherein the energy device (2) comprises a context data memory (2C), which stores internal and/or external context data,
wherein the code generation unit (2B) has access to the context data memory (2C) for generating the code as a function of the context data read out from the context data memory.

5. Energy device according to either claim 3 or claim 4,
wherein the internal context data comprise device-specific context data, in particular a device type of the energy device (2), a device ID of the energy device (2), in particular a manufacturer ID or a serial number, pre-set or configurable device parameters of the energy device (2), a current device setting or equipment provision of the energy device (2) and/or a network address of a server (6) of the device manufacturer of the relevant energy device (2), and wherein the external context data comprise environment-specific context data, in particular a geographical position of the energy device (2), and/or user-specific context data, in particular data relating to the user's first language and/or his qualification level for operating the energy device (2).

6. Energy device according to any of the preceding claims 1 to 5,
wherein the context data are captured automatically by sensors (2H) of the energy device (2) and/or inputted by the user (N) via a user interface of the energy device (2) or of a mobile terminal (3) connected to the energy device (2) via a wireless interface.

7. Energy device according to any of the preceding claims 1 to 6,
wherein the output unit (2E) of the energy device (2) comprises an optical display unit (2F), which displays a dynamically generated two-dimensional optical code which is captured by a camera (3A) of the mobile terminal (3), and/or an audio output unit (2G), which is captured by a microphone (3B) of the mobile terminal (3).

8. Energy device according to claim 7,
wherein the dynamically generated optical two-dimensional code displayed by the optical display unit (2F) is a QR code and/or a barcode.

9. Energy device according to any of the preceding claims 1 to 8,
Wherein the mobile terminal (3) of the user (N) automatically establishes, after successful decryption of the captured code, a data connection over a network (5) to a server (6) which supplies device information data which are relevant to the energy device (2) for the context specified in the context data, the relevant device information data supplied by the server (6) being transmitted to the mobile terminal (3) of the user (N) over the network.

10. Energy device according to claim 9,
wherein the relevant device information data of the energy device (2) which are received by the mobile terminal (3) of the user from the server (6) over the network (5) are prepared by a data processing unit (3C) of the mobile terminal (3) or displayed to the user directly on a display (3G) of the mobile terminal (3).

11. Energy device according to claim 10,
wherein the relevant device information data received from the server (6) are passed on at least in part from the mobile terminal (3) to the energy device (2) via a wireless interface,
wherein the relevant device information data which are passed on from the mobile terminal (3) to the energy device (2) via the wireless interface are displayed to the user on the optical display unit (2F) of the energy device (2) and/or outputted via the audio output unit (2G) of the energy device (2).

12. Energy device according to either of the preceding claims 10 and 11,
wherein the relevant device information data displayed on the display (3G) of the mobile terminal (3) and/or the optical display unit (2F) of the energy device (2) comprise an operating instruction for adjustment, operation and/or context-specific error handling, assembly instructions, equipment provision instructions, calibration instructions and/or order forms for replacement parts.

13. Energy device according to any of the preceding claims 1 to 12,
wherein the energy device (2) is an energy supply device for supplying electrical energy for a welding torch or an energy collection device for collecting electrical energy from solar radiation and/or wind power or an energy storage device comprising storage cells for storing electrical energy, which comprise electrochemical energy storage cells and/or fuel cells, or a charging device for charging energy storage cells.

14. System (1) for supplying relevant device information for an energy device (2) according to any of the preceding claims 1 to 17,
wherein the dynamically generated code outputted by the output unit (2E) of the energy device (2) is captured by a mobile terminal (3) of the user, and wherein, after successful decryption of the captured dynamically generated code by a decryption unit (3D) of the mobile terminal (3), the mobile terminal (3) establishes a data connection to a server (6) which supplies device information data for the energy device (2) which are relevant for the context specified in the context data.

15. Method for supplying relevant device information data for an energy device (2), comprising the steps of:
(a) generating (S1) a code as a function of context data by a code generation unit (2B) of the energy device (2);
(b) outputting (S2) the dynamically generated context-specific code to a mobile terminal (3) of a user (N) by an output unit (2E) of the energy device (2);
(c) establishing (S3) a data connection between the mobile terminal (3) of the user (N) and a server (6) after successful decryption the dynamic, context-specific code by a decryption unit (3D) of the mobile terminal (3); and
(d) supplying (S4) relevant device information data which are relevant for the context specified in the context data by the server (6).
